(19) United States
(12) Patent Application Publication
(10) Pub. No.: US 2006/0094806 A1
(43) Pub. Date: May 4, 2006

(54) Aqueous emulsion based pressure sensitive adhesive and pressure sensitive adhesive sheet employing same

(75) Inventors: Masayoshi Matsumoto, Tokyo (JP); Takahiro Sugimura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyo Ink Mfg. Co., Ltd., Tokyo (JP)

(21) Appl. No.: 11/305,127

(22) Filed: Dec. 19, 2005

Related U.S. Application Data
(62) Division of application No. 10/436,292, filed on May 13, 2003.

(30) Foreign Application Priority Data
May 13, 2002 (JP) 2002-136627

(51) Int. Cl. C08K 5/10

(52) U.S. Cl. 524/310; 524/460; 524/556

(57) ABSTRACT

An aqueous emulsion based pressure sensitive adhesive is disclosed that includes water and a water dispersible polymer, and has (1) a viscosity of 100 to 1000 mPa·s, (2) a dynamic surface tension of a water diluted 75% solution thereof of 59 mN/m or more at a discharge frequency of 25 Hz and a temperature of 25° C., and (3) a nonvolatile content of 50 to 70 wt %. This pressure sensitive adhesive is an emulsion composition having low viscosity and ease of handling and causing no coating defects such as ‘cissing’ and ‘retraction’ when coated on a release paper. Furthermore, there is disclosed a process for producing a pressure sensitive adhesive sheet that includes a release material, a pressure sensitive adhesive layer, and a substrate, the pressure sensitive adhesive layer being formed from the above aqueous emulsion based pressure sensitive adhesive.

### CROSS REFERENCE TO RELATED APPLICATIONS

This application is based upon and claims the benefit of priority from prior Japanese Patent Application P2002-136627, filed on May 13, 2002; the entire contents of which are incorporated by reference herein.

### BACKGROUND OF THE INVENTION

1. Field of the Invention

The present invention relates to an aqueous emulsion based pressure sensitive adhesive and a pressure sensitive adhesive sheet employing same.

2. Description of the Related Art

To improve the coatability of an aqueous emulsion, various proposals have been made from the viewpoint of chemical composition, physical parameters, etc. Among those proposals, with regard to proposals regarding the composition, most thereof concern the addition of a surfactant, or selection of the type thereof, and with regard to proposals regarding the physical parameters, most thereof refer to lowering of the surface tension.

In particular, since aqueous emulsion based pressure sensitive adhesives are usually subjected to transfer coating in which the pressure sensitive adhesive is applied on a highly water and oil repellent release paper and a substrate is laminated on top of the pressure sensitive adhesive layer so obtained, it is important for the pressure sensitive adhesive to be able to wet the release paper rapidly.

In the case where a pressure sensitive adhesive is applied at a higher speed and the coating 80 obtained is dried, if a single production line is employed, then it is inevitable that the drying time for the coating will be reduced, and the pressure sensitive adhesive is therefore required to have a high solids content. Furthermore, from the viewpoint of reducing the transport cost for the pressure sensitive adhesive, there is a demand for it to have a high solids content. Moreover, due to the necessity for ensuring wettability during coating, there is a demand for the pressure sensitive adhesive to have high viscosity, thus degrading the ease of handling during preparation and application of the pressure sensitive adhesive, and the ease of cleaning of the production line.

Furthermore, in order to enhance the productivity and the yield (reduction of coating defects) to meet the recent requirement for cost reduction, pressure sensitive adhesives have been required to be suitable for application at a wide range of speeds, from low speed to high speed.

The coating defects refer to loss of uniformity of the coating for some reason or other, and various forms can be considered including ‘cissing’ and ‘retraction’. ‘Cissing’ (repellence) means the occurrence of circular or oval shaped non-coated areas in parts of the coating, and such areas are so called because they look as if there has been repellence from a release liner. When cissing occurs, the product is of course defective. ‘Retraction’ means the retraction of coating edges at both sides of a web toward the web center relative to an intended coating position at which a coating solution is supplied from a discharge outlet, thus resulting in a reduction of the coating area and an increase in the thickness at the coating edges. Conventional techniques for controlling the surface tension or the dynamic surface tension of an aqueous emulsion are known from Japanese Unexamined Patent Publication Nos. 10-195389 and 2001-220553. Japanese Unexamined Patent Publication No. 10-195389 discloses an aqueous coating composition that includes a rheology modified polymer and a material having a surface tension of less than 35 dyn/cm in order to improve the coatability and the wettability. Japanese Unexamined Patent Publication No. 2001-220553 discloses a technique in which an aqueous solution of a malate diester that exhibits a dynamic surface tension of 45 dyn/cm or less is used in order to decrease the surface tension.

### SUMMARY OF THE INVENTION

It is an object of the present invention to provide an aqueous emulsion based pressure sensitive adhesive that does not cause coating problems such as ‘cissing’ and ‘retraction’ during coating a release paper, and that has low viscosity and gives ease of handling.

A first aspect of the present invention provides an aqueous emulsion based pressure sensitive adhesive that includes water and a water dispersible polymer, and has (1) a viscosity of 100 mPa·s or more and not exceeding 1000 mPa·s, (2) a dynamic surface tension of a water diluted 75% solution thereof of 59 mN/m or more at a discharge frequency of 25 Hz and a temperature of 25° C., and (3) a nonvolatile content of 50 wt % or more and not exceeding 70 wt %. Use, as the pressure sensitive adhesive, of an emulsion having such characteristics can realize both high coatability and low viscosity of the pressure sensitive adhesive.

A second aspect of the present invention provides a process for producing a pressure sensitive adhesive sheet that includes a release material, a pressure sensitive adhesive layer, and a substrate, the process including steps of; coating the release material with the above-mentioned aqueous emulsion based pressure sensitive adhesive to form a pressure sensitive adhesive layer having a dry film thickness of 8 to 25 μm; and laminating the substrate on top of the above-mentioned pressure sensitive adhesive layer.

A third aspect of the present invention provides a pressure sensitive adhesive sheet obtained by the above-mentioned process for producing a pressure sensitive adhesive sheet.

### BRIEF DESCRIPTION OF THE DRAWINGS

FIG. 1 is a graph showing the dynamic surface tension of pressure sensitive adhesives of Examples and Comparative Examples of the present invention.

FIG. 2 is a schematic cross sectional view of one embodiment of the pressure sensitive adhesive sheet according to the present invention.

### DETAILED DESCRIPTION OF EMBODIMENTS

The aqueous emulsion based pressure sensitive adhesive (hereinafter, simply called ‘PSA’) according to the present invention has (1) a viscosity of 100 to 1000 mPa·s, (2) a dynamic surface tension of a water diluted 75% solution thereof of 59 mN/m or more at a discharge frequency of 25 Hz and a temperature of 25° C., and (3) a nonvolatile content of 50 to 70 wt %.

As a result of an investigation by the present inventors into various factors relating to the coatability of the PSA, it has been found that an emulsion composition having a dynamic surface tension, viscosity, and solids content that satisfy the above-mentioned characteristics (1) to (3) can realize good coatability. That is, in the application of the PSA, it is more important to reduce the attractive force working between the PSA coating solution and a discharge outlet of a coating machine than to control the wettabillty of a material to be coated with the PSA (attractive force between the material to be coated and the coating solution). The conclusion drawn therefrom is that it is necessary to increase the dynamic surface tension of the PSA as described below. In other words, excellent, defect-free coating can be carried out by designing the composition of the coating solution such that the wettability of the discharge outlet is made poor, rather than improving the wettability of the material to be coated. That is, as controlling factors, ‘detachment’ of the coating solution from the discharge outlet has priority over ‘wettability’ of a release sheet, and it is necessary to design the composition of the PSA while taking into consideration primarily the ‘detachment’ from the discharge outlet.

Application of the PSA is carried out in a dynamic mode and takes a very short time in most cases. It is also known that, in the case of an aqueous emulsion based coating solution, a certain period of time is required before a surfactant is oriented at an interface and reaches equilibrium. It can be surmised therefrom that the state of the surface or the interface of a liquid during coating differs from the equilibrium state. That is, in order to control the coatability, it is very important to carry out measurement in a state in which the interface of the coating solution has not yet reached equilibrium, that is, in a dynamic state, and in order to obtain a composition having improved coatability, it is useful to control the dynamic surface tension.

In the present invention, a value for the dynamic surface tension is measured by a ‘bubble pressure method’, which is a general method for measuring the dynamic surface tension, but any method can be employed as long as the surface tension at a dynamic gas-liquid interface can be measured.

The bubble pressure method is now explained. A capillary is immersed vertically into a solution sample, and air or an inert gas such as nitrogen or argon is discharged through the capillary so as to generate a bubble in the solution at a certain depth. When this bubble forms a hemisphere at the extremity of the capillary, the pressure is a maximum, and in the bubble pressure method the surface tension is calculated from this maximum pressure using the Laplace equation.

The interval at which bubbles are generated during measurement is called the bubble rate (i.e., discharge frequency or bubble frequency), and the unit is Hz. In this way, the surface tension is measured while continuously discharging bubbles to form a dynamic surface. Changing the bubble rate from a high frequency to a low frequency makes the bubble surface lifespan vary, and a value for the surface tension in a dynamic state can thus be obtained.

As a dynamic surface tension measuring device, there can be cited as an example a ‘BP2 bubble pressure dynamic surface tensiometer’ manufactured by Krüss GmbH.

When measuring the dynamic surface tension, because of limitations of the capability of the device used, it is necessary to dilute the PSA to such a concentration that the device can discharge bubbles. In the present invention, 75 parts by weight of the PSA is diluted with 25 parts by weight of ion-exchanged water, and measurement is carried out using this water diluted 75 wt % PSA solution. Since the dynamic surface tension varies depending on the dilution concentration, it is necessary to employ a fixed concentration for measurement, and this dilution concentration depends on the concentration at which the device can discharge bubbles.

Since temperature is also a factor that influences the measured value of the dynamic surface tension, in the present invention measurement is carried out at a fixed temperature of 25° C. Air is used as the gas that is discharged for forming bubbles.

The PSA of the present invention has a value for the dynamic surface tension measured under the above-mentioned conditions of 59 mN/m or more at a bubble discharge interval of 25 to 30 Hz, and particularly at 25 Hz. The value for the dynamic surface tension is preferably 65 mN/m or more, and more preferably 65 mN/m or more and not exceeding 72 mN/m.

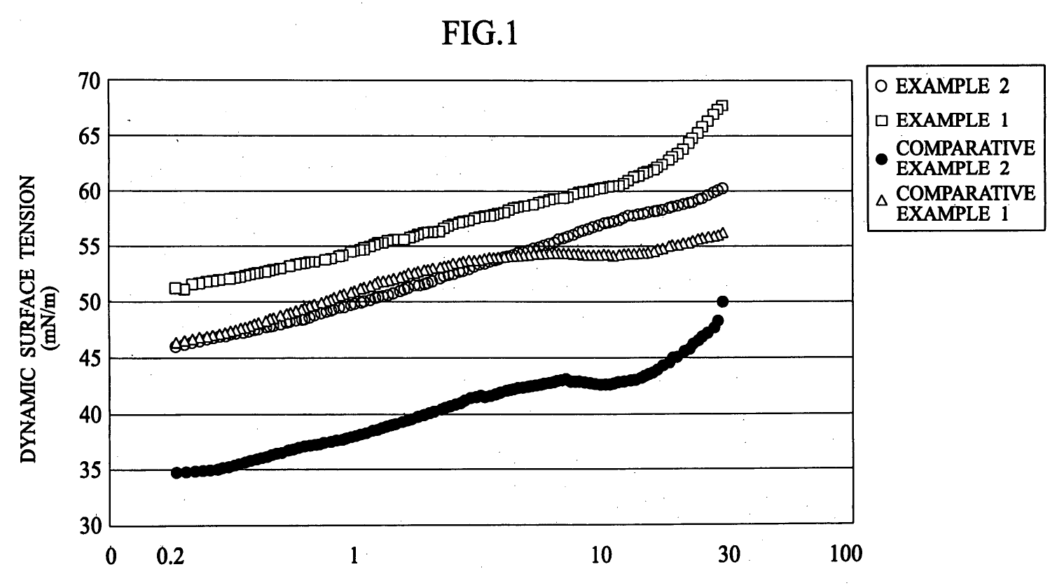

It can be expected that, if the dynamic surface tension is less than 59 mN/m, then the coating PSA forms a meniscus and wraps around to the reverse side of a blade, etc., which is a discharge portion of a coating machine, thus causing nonuniformity in the coating (see FIG. 1).

The PSA preferably has a nonvolatile content of 50 to 70 wt %, and more preferably 60 to 65 wt %.

The PSA preferably has a viscosity of 100 to 1000 mPa·s, and more preferably 200 to 600 mPa·s. The viscosity here is a value measured at 25° C. by a BL viscometer using a #4 rotor at 60 rpm.

The PSA of the present invention is an emulsion composition containing a water dispersion medium and a water dispersible polymer, that is, an aqueous polymer dispersion (an aqueous resin dispersion or a water dispersible polymer dispersion). The proportion of water in the composition corresponds to the volatile component of the PSA, and it is therefore preferable for water to be present at 30 to 50 wt %.

The water dispersible polymer is preferably a polymer obtained by emulsion polymerization using a radically polymerizable monomer, and preferably an acrylic copolymer, that is, a copolymer consisting of monomers containing one or more types of a (meth)acrylic acid ester. The (meth)acrylic acid here means acrylic acid and methacrylic acid. The (meth)acrylic acid ester is preferably an alkyl (meth)acrylate having 1 to 13 alkyl chain carbons.

More specifically, this water dispersible polymer is preferably a copolymer consisting of monomers containing a polymerizable unsaturated carboxylic acid and an alkyl (meth)acrylate having 1 to 13 alkyl chain carbons, the copolymer being obtained by emulsion polymerization using an emulsifier and a chain transfer agent. This copolymer may further contain a monomer that can copolymerize with both the alkyl (meth)acrylate and the polymerizable unsaturated carboxylic acid.

As the emulsifier, it is preferable to use at least one of an ammonia-neutralized anionic surfactant and a nonionic surfactant. It is more preferable to use the two types of surfactants above in combination, and in this case it is preferable for the ratio (ratio by weight) of the solids contents of the ammonia-neutralized anionic surfactant to the nonionic surfactant to be 1:1.2 to 1:1.5. The ammonia-neutralized anionic surfactant preferably has a polymerizable functional group and also has radical polymerizability. Furthermore, both the ammonia-neutralized anionic surfactant and the nonionic surfactant preferably have an alkylene oxide chain. It is preferable for the number of repeating units (m) in the alkylene oxide chain of the ammonia-neutralized anionic surfactant to be smaller than the number of repeating units (n) in the alkylene oxide chain of the nonionic surfactant, and it is more preferable that 5≦m≦20 and n≧50. From the viewpoint of emulsion stability and polymerization stability, it is preferable that n s 100. The PSA of the present invention can preferably be obtained by using as the emulsifier the above mentioned ammonia-neutralized anionic surfactant and the nonionic surfactant, for example at the above-mentioned ratio.

As the chain transfer agent, a thioglycolic acid ester compound is preferably used, and a thioglycolic acid ester compound having a methoxy group is more preferably used.

As hereinbefore described, in a preferred embodiment, the PSA contains a water dispersible polymer dispersion obtained by emulsion polymerization of an alkyl (meth)acrylate having 1 to 13 alkyl chain carbons and a polymerizable unsaturated carboxylic acid (a monomer that can copolymerize with them may further be included) using a polymerizable ammonia-neutralized anionic surfactant and/or a nonionic surfactant (preferably both) and a thioglycolic acid ester compound having a methoxy group.

The above-mentioned alkyl (meth)acrylate having 1 to 13 alkyl chain carbons means an acrylic acid ester in which the number of carbons of a straight-chain or branched aliphatic alcohol forming the ester is 1 to 13, and the corresponding methacrylic acid ester; specific examples thereof include methyl (meth)acrylate, ethyl (meth)acrylate, butyl (meth)acrylate, hexyl (meth)ac rylate, octyl (meth)acrylate, 2-ethylhexyl (meth)acrylate, decyl (meth)acrylate, and dodecyl (meth)acrylate. They can be used singly or in a combination of two or more types. The number of alkyl chain carbons in the alkyl ester is more preferably 3 to 12.

The above-mentioned polymerizable unsaturated carboxylic acid is copolymerizable with the above-mentioned alkyl (meth)acrylate, and specific examples thereof include acrylic acid, methacrylic acid, maleic anhydride, maleic acid, itaconic acid, and crotonic acid. They can be used singly or in a combination of two or more types.

As the monomer that can copolymerize with the above-mentioned (meth)acrylic acid ester and polymerizable unsaturated carboxylic acid, a polar functional group-containing vinyl monomer can be preferably used. This is a vinyl monomer having one or more functional groups selected from the group consisting of a hydroxyl group, a methylol group, an amino group, an amide group, a glycidyl group, a phosphate group, a sulfonic acid group, an ethyleneimine group, and an isocyanate group; specific examples thereof include 2-hydroxypropyl (meth)acrylate, 2-hydroxyethyl (meth)acrylate, polyethylene glycol acrylate, glycidyl acrylate, glycidyl methacrylate, mono-(2-hydroxyethyl-α-chloroacrylate) acid phosphate, vinyl isocyanate, N-methylolacrylamide, N-methylolmethacrylamide, N-methylaminoethyl acrylate, N-tributylaminoethyl acrylate, N,N-dimethylaminoethyl acrylate, N,N-dimethylaminoethyl methacrylate, N,N-diethylaminoethyl methacrylate, acrylamide, methacrylamide, vinylpyrrolidone, acryloylmorpholine, N-vinylformamide, sodium sulfoxylethyl methacrylate, and sodium vinylsulfonate. They can be used singly or in a combination of two or more types.

Other than the above-mentioned polar functional group-containing vinyl monomer component, there can be used as a comonomer component one or more types of polymerizable monomer selected from the group consisting of a vinyl ester, vinylpyridine, vinyl acetate, vinyl propionate, styrene, acrylonitrile, methacrylonitrile, butadiene, and chloroprene.

The proportions of the alkyl (meth)acrylate having 1 to 13 alkyl chain carbons (A) and the polymerizable unsaturated carboxylic acid (B), which are copolymer components of the water dispersible polymer, are preferably 99.9 to 90 wt % for A and 0.1 to 10 wt % for B. When the monomer (C) that can copolymerize with A and B is further included, it is preferable for A to be 99.8 to 60 wt %, for B to be 0.1 to 10 wt %, and for C to be 0.1 to 30 wt %.

The above-mentioned ammonia-neutralized anionic surfactant is an anionic surfactant in the form of an ammonium salt as a result of neutralization of an acid group of the surfactant with ammonia, it is preferably one having in the molecule a polymerizable functional group (double bond) and an alkylene oxide chain that has a number of repeating units m of 5≦m≦20, and the alkylene oxide chain is preferably a polyethylene oxide chain. Preferred specific examples include those formed by ammonia neutralization of acid end groups, such as, for example, a higher fatty acid salt having an alkylene oxide chain and a polymerizable functional group, an alkyl sulfate salt having an alkylene oxide chain and a polymerlzable functional group, an alkyl ether sulfate salt having an alkylene oxide chain and a polymerizable functional group, and an alkyl sulfosuccinate salt having an alkylene oxide chain and a polymerizable functional group. They can be used singly or in a combination of two or more types.

More specific examples include commercial products such as the ‘Newcol SF series’ manufactured by Nippon Nyukazai Co., Ltd., represented by general formula (I) below: 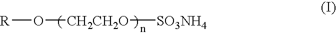
(in the formula, R denotes an alkyl group), ‘Adeka Reasoap SE-10N’ manufactured by Asahi Denka Co., Ltd., represented by formula (II) below: 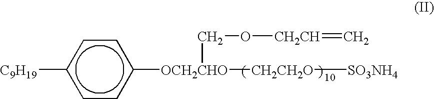
‘Adeka Reasoap SR-10N’ manufactured by Asahi Denka Co., Ltd., represented by formula (III) below: 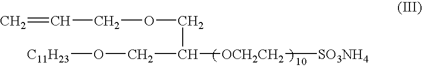
and the ‘Aqualon series’ and ‘Aqualon HS series’ manufactured by Dai-ichi Kogyo Selyaku Co., Ltd., which are polymerizable anionic surfactants having an ethylene oxide chain, a polymerizable functional group (double bond), and a terminal sulfonic acid group. It is also possible to neutralize with ammonia a phosphoric acid ester type surfactant, represented by ‘Kayarad’, which is manufactured by Nippon Kayaku Co., Ltd.

The above-mentioned nonionic surfactant preferably has an alkylene oxide chain, and the number of repeating units n in the alkylene oxide chain is preferably n≧50. Specific examples thereof include a polyoxyethylene alkyl ether, a polyoxyethylene phenyl ether, a polyoxyethylene sorbitan higher fatty acid ester, and a polyoxyethylene glycerol higher fatty acid ester. They can be used singly or in a combination of two or more types.

More specific examples include the ‘Newcol series’ manufactured by Nippon Nyukazai Co., Ltd., represented by general formula (IV) below: 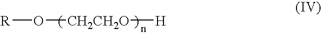
(in the formula, R denotes an alkyl group), and the ‘Aqualon RN series’ manufactured by Dai-ichi Kogyo Seiyaku Co., Ltd., represented by general formula (V) below: 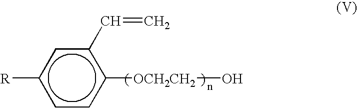
(in the formula, R denotes an alkyl group).

As the emulsifier for emulsion polymerization, the two types of surfactants are preferably used in a combination at a solids content ratio (ratio by weight) of ammonia-neutralized anionic surfactant:nonionic surfactant=1:1.2 to 1:1.5.

The amount of emulsifier added as a solids content proportion is preferably 0.1 to 5.0 wt % based on the total amount of monomers in the water dispersible polymer (that is, 0.1 to 5.0 parts by weight relative to 100 parts by weight of the total of the monomers), and more preferably 0.5 to 2.5 wt %. When a plurality of surfactants are used in combination as described above, the total amount thereof used is also preferably in the above-mentioned range.

The above-mentioned chain transfer agent is used for controlling the molecular weight of the water dispersible polymer, and is preferably one or more types selected from the group consisting of a thioglycolic acid ester compound, a thioglycolic acid ester compound having a methoxy group, and a mercaptopropionic acid ester compound. It is preferable to use, for example, one or more types from octyl thioglycolate, methoxybutyl thioglycolate, methoxybutyl β-mercaptopropionate, etc. In particular, as exemplified, the thioglycolic acid ester compound having a methoxy group as a branched chain (in its side chain) is a hydrophilic chain transfer agent, and is preferred since the molecular weight can be controlled effectively with a smaller amount thereof than the amounts of other thioglycolic acid derivatives and mercaptan derivatives required. The amounts of these compounds used is preferably 0.01 to 0.2 wt % based on the total amount of the monomers, and more preferably 0.05 to 0.1 wt %.

The polymerization reaction can employ a water-soluble thermally labile initiator, including a persulfate such as potassium persulfate or ammonium persulfate, an azobis type cationic salt, and a hydroxyl group adduct, and can also use a redox initiator.

Examples of the redox initiator include a combination of an organic peroxide such as t-butyl hydroperoxide, benzoyl peroxide, or cumene hydroperoxide with a reducing agent such as rongalite or sodium metabisulfite, a combination of potassium persulfate or ammonium persulfate with rongalite, sodium thiosulfate, etc., and a combination of hydrogen peroxide with ascorbic acid.

As other components, the PSA composition may include a tackifier in order to improve the initial adhesive power and enhance the adhesive power to a specific substrate. Examples of the tackifier include a rosin resin, a phenol resin, a polyterpene, an acetylene resin, a petroleum hydrocarbon resin, an ethylene vinyl acetate copolymer, a synthetic rubber, and natural rubber, and one or more types thereof can be used.

When formulating the PSA composition, various types of additives can be added as necessary, and examples thereof include a wetting agent (a surfactant for preventing cissing, etc.), an antifoaming agent, a neutralizing agent, a plasticizer, a viscosity increasing agent, a filler, a coloring agent, a preservative, an anti-mold agent, and a solvent.

The pH of the PSA is preferably 4 to 9 from the viewpoint of the storage stability over time and the working environment, and more preferably 7.0 to 8.5.

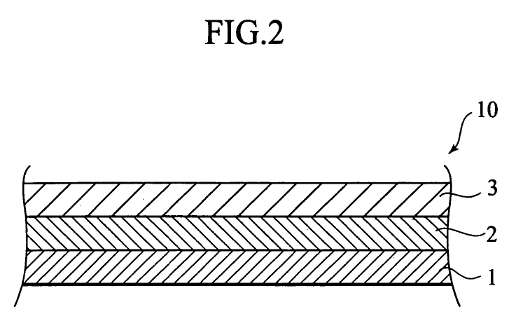

FIG. 2 shows schematically one embodiment of a PSA sheet according to the present invention, the PSA sheet 10 including a release material 1, a PSA layer 2, and a substrate 3, the PSA layer 2 being formed from the above-mentioned PSA of the present invention.

The release material 1 and the substrate 3 are not particularly limited; as the release material there can be used a known release paper or a known release film formed by coating a paper such as a wood free paper or a plastic film with a release agent, and as the substrate there can be used a known substrate such as a wood free paper, an art paper, a cast coated paper, a polyester film, a polyethylene film, or a polypropylene film.

A process for producing the PSA sheet is not particularly limited either, and it can be obtained preferably by, for example, transfer coating, in which a PSA is applied on top of a release material using a comma coater, a reverse coater, a slot die coater, etc., and dried, and a substrate is then laminated and pressed on top of the PSA layer so obtained. The coat weight of the PSA is preferably 5 to 50 g/m² as a dry weight, and more preferably 10 to 25 g/m². The dry film thickness of the PSA layer is preferably 8 to 25 μm.

The process for producing the PSA layer of the present invention employs the above-mentioned transfer coating method and includes steps of; applying a PSA on a release material so as to form a PSA layer having a dry film thickness of 8 to 25 μm; and laminating a substrate on top of the PSA layer.

The method for applying the PSA is not particularly limited and can employ a coating machine such as, for example, a comma coater, a die coater, a slot die coater, a curtain coater, a roll coater, a reverse roll coater, or a gravure coater.

The coating speed is not particularly limited, but is preferably 3 m/min to 1000 m/min, and more preferably 100 m/min to 400 m/min.

### EXAMPLES

The present invention is now explained by reference to Examples, but the present invention is not limited thereby. In the examples below, ‘parts’ denotes ‘parts by weight’ and ‘%’ denotes ‘wt %’.

### Example 1

48 parts of butyl acrylate, 48 parts of 2-ethylhexyl acrylate, 1 part of acrylic acid, 3 parts of methacrylic acid, and 0.08 parts of octyl thioglycolate were mixed with 1.0%, as a solids content proportion based on the total amount of the above monomers, of Adeka Reasoap SE-10N of the above-mentioned formula (II) as the ammonia-neutralized anionic surfactant (hereinafter, simply termed ‘anionic surfactant’), and 1.2% of Aqualon RN-50 manufactured by Dai-ichi Kogyo Seiyaku Co., Ltd., which is represented by formula (VI) below: 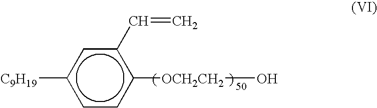
as the nonionic surfactant, ion-exchanged water was added thereto so that the solids content was 70%, and the mixture was emulsified and charged into a dropping funnel.

A polymerization vessel equipped with a stirrer, a thermometer, the dropping funnel, and a reflux condenser was charged with a predetermined amount of ion-exchanged water, the water was saturated with nitrogen gas and stirred, the reaction system was heated to 80° C., and 0.075%, as a solids content proportion based on the total amount of the monomers, of a 5% aqueous solution of ammonium persulfate was added. 5 minutes after the addition, the emulsion in the dropping funnel was added dropwise so as to start a reaction while adding dropwise a 5% aqueous solution of ammonium persulfate (0.225% as a solids content ratio based on the total amount of the monomers) over 3 hours.

After the dropwise addition was completed, a 5% aqueous solution of ammonium persulfate (0.04% as a solids content ratio based on the total amount of the monomers) was added twice with an interval of 30 minutes. The mixture was further aged at 80° C. for 2 hours while stirring, then cooled and neutralized with ammonia to separate an aqueous resin dispersion.

0.1 parts of an antifoaming agent (Defoamer 777 manufactured by San Nopco Ltd.), and 0.1 parts of a preservative (FX-80 manufactured by Shoei Kagaku K.K.) were added to 100 parts of the aqueous resin dispersion thus obtained, and further ammonia and ion-exchanged water were added thereto so as to adjust the nonvolatile content to 60.5%, thus giving a PSA. The viscosity of the PSA was measured to be 450 mPa·s by a BL viscometer using a #4 rotor at 60 rpm. The pH of the PSA was 7.2.

The dynamic surface tension of the PSA was measured using a BP2 bubble pressure dynamic surface tensiometer manufactured by Krüss GmbH. A measurement sample was prepared by diluting the PSA to 75% with ion-exchanged water. Air was used as the gas for forming bubbles, the temperature during measurement was 25° C., the bubble rate was 0.2 to 30 Hz, and a value for the dynamic surface tension at each frequency was obtained.

The PSA thus obtained was applied by a comma coater on a commercial release paper at a coat weight (dry weight) of 13 to 15 g/m², made to pass at a coating speed of about 4 m/min through a body oven at 100° C. for 45 sec so as to remove the dispersion medium, and coating defects such as retraction and cissing were inspected.

### Example 2

The procedure of Example 1 was repeated except that N-2360 (in the above-mentioned general formula (IV), R=C₁₂₋₁₃ alkyl group, n=60) manufactured by Nippon Nyukazai Co., Ltd. was used instead of Aqualon RN50 as the nonionic surfactant.

### Example 3

The procedure of Example 1 was repeated except that the amounts of the anionic surfactant and the nonionic surfactant added were 1.0% and 1.5% respectively as solids content proportions based on the total amount of the monomers (the same applies below).

### Example 4

The procedure of Example 1 was repeated except that the monomer composition ratio was 46 parts of butyl acrylate, 46 parts of 2-ethylhexyl acrylate, 5 parts of acrylic acid, and 3 parts of methacrylic acid; 1.0% of Aqualon KH-10 manufactured by Dai-ichi Kogyo Seiyaku Co., Ltd., which is represented by formula (VII) below: 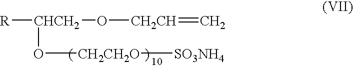
(in the formula, R=C₁₀ or C₁₂ alkyl group) was added as the anionic surfactant, and 1.2% of the above-mentioned N-2360 was added as the nonionic surfactant.

### Example 5

The procedure of Example 1 was repeated except that the monomer composition ratio was 38 parts of butyl acrylate, 38 parts of 2-ethylhexyl acrylate, 1 part of acrylic acid, 3 parts of methacrylic acid, and 20 parts of ethyl acrylate; 1.0% of the above-mentioned Aqualon KH-10 was added as the anionic surfactant, and 1.2% of the above-mentioned N-2360 was added as the nonionic surfactant.

### Example 6

The procedure of Example 1 was repeated except that 1.0% of Adeka Reasoap SR-10N of the above-mentioned formula (III) was added as the anionic surfactant, and 1.2% of the above-mentioned N-2360 was added as the nonionic surfactant.

### Example 7

The procedure of Example 1 was repeated except that 0.5% of the above-mentloned Aqualon KH-10 and 0.5% of RA9601 manufactured by Nippon Nyukazai Co., Ltd., which is represented by general formula (VIII) below: 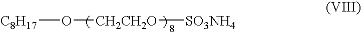
were used as the anionic surfactant, and 1.2% of the above-mentioned N-2360 was used as the nonionic surfactant.

### Example 8

The procedure of Example 1 was repeated except that 0.8% of the above-mentioned Aqualon KH-10 was used as the anionic surfactant, and 1.2% of N-1860 manufactured by Nippon Nyukazai Co., Ltd. (in the above-mentioned general formula (IV), R=C₁₈ alkyl group, n=60) was used as the nonionic surfactant.

### Example 9

The procedure of Example 1 was repeated except that methoxybutyl thioglycolate was used instead of octyl thioglycolate.

### Comparative Example 1

The procedure of Example 1 was repeated except that 0.5 parts of Adekapluronic (Adekanol) L88 (ethylene oxide/propylene oxide copolymer) manufactured by Asahi Denka Co., Ltd. was added to 100 parts of the PSA obtained in Example 1.

### Comparative Example 2

The procedure of Example 1 was repeated except that N-2320 manufactured by Nippon Nyukazai Co., Ltd.. (in the above-mentioned general formula (IV), R=C₁₂₋₁₃ alkyl group, n=20) was used as the nonionic surfactant instead of Aqualon RN50.

### Comparative Example 3

The procedure of Example 1 was repeated except that the proportions of the anionic surfactant and the nonionic surfactant added were 1.0% and 0.8% respectively.

### Comparative Example 4

The procedure of Example 1 was repeated except that the above-mentioned RA9601 was used as the anionic surfactant and the above-mentioned N-2360 was used as the nonionic surfactant.

The results of Examples 1 to 9 and Comparative Examples 1 to 4 are shown together in Table 1. In Table 1, the total amount of emulsifier is a total amount (proportion by weight of solids content) based on the total amount of monomers, and the dynamic surface tension is a value at 25 Hz. The evaluation criteria for the coatability were as below, and the larger the figure, the better the performance.

5 . . . Almost no retraction and cissing.

4 . . . Retraction: less than 2 mm, cissing: less than 1 location per 10 m² of coated area.

3 . . . Retraction: 2 mm or more and less than 10 mm, cissing: 1 or more and less than 5 locations per 10 m² of coated area.

2 . . . Retraction: 10 mm or more and less than 20 mm, cissing: 5 or more and less than 10 locations per 10 m² of coated area.

1 . . . Retraction: 20 mm or more, cissing: 10 or more locations per 10 m² of coated area.

FIG. 1 is a graph showing the dynamic surface tension of Examples 1 and 2 and Comparative Examples 1 and 2.

As is clear from Table 1, the PSAs of the Examples showed better coatability without causing coating problems and defects such as ‘retraction’ and ‘cissing’ compared with the PSAs of the Comparative Examples.

TABLE 1

| | | Example | | | | | |
|---|---|---|---|---|---|---|---|
| | 1 | 2 | 3 | 4 | 5 | 6 | 7 |
| Ratio of anionic/ | 1/1.2 | 1/1.2 | 1/1.5 | 1/1.2 | 1/1.2 | 1/1.2 | 1/1.2 |
| nonionic | | | | | | | |
| Total amount of | 2.2 | 2.2 | 2.5 | 2.2 | 2.2 | 2.2 | 2.2 |
| emulsifier (wt %) | | | | | | | |
| Repeating units (n) | 50 | 60 | 50 | 60 | 60 | 60 | 60 |
| of nonionic | | | | | | | |
| surfactant | | | | | | | |
| Viscosity (mPa · s) | 450 | 470 | 470 | 480 | 300 | 450 | 400 |
| Dynamic surface | 66.4 | 59.5 | 64.0 | 59.0 | 59.2 | 61.0 | 59.2 |
| tension | | | | | | | |
| (mN/m) (25 Hz) | | | | | | | |
| Coating performance | 5 | 5 | 5 | 4 | 4 | 5 | 4 |

| | Example | | Comparative Example | | | |
|---|---|---|---|---|---|---|
| | 8 | 9 | 1 * | 2 | 3 | 4 |
| Ratio of anionic/nonionic | 1/1.5 | 1/1.2 | 1/1.2 | 1/1.2 | 1/0.8 | 1/1.2 |
| surfactant solids contents | | | | | | |
| Total amount of | 2.0 | 2.2 | 2.2 | 2.2 | 1.8 | 2.2 |
| emulsifier (wt %) | | | | | | |
| Repeating units (n) of | 60 | 50 | 50 | 20 | 50 | 60 |
| nonionic surfactant | | | | | | |
| Viscosity (mPa · s) | 300 | 440 | 470 | 470 | 470 | 350 |
| Dynamic surface tension | 63.5 | 66.0 | 55.7 | 47.0 | 52.7 | 49.0 |
| (mN/m) (25 Hz) | | | | | | |
| Coating performance | 5 | 5 | 2 | 1 | 3 | 3 |

Note
* Adekapluronic L88 added.

It is to be noted that, besides those- already mentioned above, many modifications and variations of the above embodiments may be made without departing from the novel and advantageous features of the present invention. Accordingly, all such modifications and variations are intended to be included within the scope of the appended claims.

1-13. (canceled)

14. A process for producing an aqueous emulsion based pressure sensitive adhesive comprising water and a water dispersible polymer, and having
(1) a viscosity of 100 to 1000 mPa·s;
(2) a dynamic surface tension of a water diluted 75% solution thereof of 59 mN/m or more at a discharge frequency of 25 Hz and a temperature of 25° C.; and
(3) a nonvolatile content of 50 to 70 wt. %,
the process comprising:
preparing a water dispersible polymer by emulsion-copolymerization of a polymerizable unsaturated carboxylic acid and an alkyl (meth)acrylate having 1 to 13 alkyl chain carbons, using an emulsifier and a chain transfer agent, wherein the emulsifier comprises an ammonia-neutralized anionic surfactant having a polymerizable functional group and an alkylene oxide chain, and a nonionic surfactant having an alkylene oxide chain, the number of repeating units (m) in the alkylene oxide chain of the ammonia-neutralized anionic surfactant being 5≦m≦20, the number of repeating units (n) in the alkylene oxide chain of the nonionic surfactant being n≧50 and the ratio by weight of the solids content of the ammonia-neutralized anionic surfactant to that of the nonionic surfactant being 1:1.2 to 1:1.5.

15. The process according to claim 14, wherein the chain transfer agent comprises a thioglycolic acid ester compound having a methoxy group.

16. The aqueous emulsion based pressure sensitive adhesive obtained by the process according to claim 14.

17. A process for producing a pressure sensitive adhesive sheet that includes a release material, a pressure sensitive adhesive layer, and a substrate, the process comprising:
coating the release material with the aqueous emulsion based pressure sensitive adhesive according to claim 16 to form a pressure sensitive adhesive layer having a dry film thickness of 8 to 25 μm; and
laminating the substrate on top of the pressure sensitive adhesive layer.

18. A pressure sensitive adhesive sheet obtained by the process according to claim 17.
